(19) United States
(12) Patent Application Publication
(10) Pub. No.: US 2007/0077834 A1
(43) Pub. Date: Apr. 5, 2007

(54) Absorbent cleaning pad having a durable cleaning surface and method of making same

(75) Inventors: James Hanson, Lawton, MI (US); Frank S. Glaug, Chester Springs, PA (US)

Correspondence Address: RATNERPRESTIA, P O BOX 980, VALLEY FORGE, PA, 19482-0980, US

(73) Assignee: Tyco Healthcare Retail Services AG

(21) Appl. No.: 11/240,929

(22) Filed: Sep. 30, 2005

(51) Int. Cl. B32B 5/02

(52) U.S. Cl. 442/59; 442/118; 442/152; 442/153; 156/60

(57) ABSTRACT

A surface cleaning pad having a pad body and a cleaning surface is provided. The surface cleaning pad comprises a pad body having a matrix web formed from binder fibers and at least one cleaning surface configured for contact with a surface to be cleaned, wherein a density of the matrix web at the cleaning surface is greater than a density of the matrix web at a location spaced from the cleaning surface.

### FIELD OF THE INVENTION

The present invention relates to an absorbent cleaning pad and to a method for fabricating the absorbent cleaning pad with a durable cleaning surface.

### BACKGROUND OF THE INVENTION

Modern floor cleaning implements employ disposable wipes or cleaning sheets, which are releasably affixed to the head of a mopping implement, and which can conveniently be discarded and replaced after the cleaning sheet is sufficiently soiled. A side of the disposable absorbent cleaning sheet is in contact with a surface to be cleaned.

The cleaning sheet should be of sufficient integrity to withstand the common mopping action stress and pressure and exhibit durability throughout one or more mopping sessions. In particular, the cleaning surface of the cleaning sheet, which endures a significant portion of the stress and pressure should be adequately robust to substantially resist significant abrasion and deformation.

Various disposable cleaning sheets have been proposed. For example, a cleaning pad surface is disclosed in U.S. Pat. No. 6,725,512, which illustrates a three-dimensional image imparted on the cleaning surface of a cleaning pad. The three-dimensional image of the cleaning pad is intended to induce the formation of lather due to pronounced surface projections that come in contact with the soiled surface and provide air passageways that are parallel to the plane of the substrate. The imaged nonwoven fabric is claimed to reduce the potential of fiber contamination at the cleaning surface and is intended to be used in a vigorous manner without substantially abrading.

Nevertheless, there continues to be a need for improved cleaning sheets or cleaning pads.

### SUMMARY OF THE INVENTION

According to one aspect of the invention, a surface cleaning pad is provided having a pad body comprising a matrix web formed from binder fibers (or a mixture of binder fibers and other fibers) and at least one cleaning surface configured for contact with a surface to be cleaned. The density of the matrix web at the cleaning surface is greater than a density of the matrix web at a location spaced from the cleaning surface.

According to another aspect of the invention, a method is provided for forming a cleaning pad body comprising a matrix web formed from binder fibers and a cleaning surface. The method includes depositing a first concentration by weight of binder fibers so as to define the cleaning surface. A second concentration by weight of binder fibers is deposited onto the first concentration by weight of binder fibers, wherein the second concentration by weight of binder fibers is less than the first concentration by weight of binder fibers. The first and second concentrations by weight of binder fibers are bound together to form the matrix web.

According to yet another aspect of the invention, a method is provided for forming a cleaning pad body comprising a matrix web formed from binder fibers and a cleaning surface. The method includes depositing a first portion of substrate comprising binder fibers so as to define the cleaning surface. A second portion of substrate comprising binder fibers is deposited onto the first portion of substrate. The first and second portions of substrate are bound together to form the matrix web structure. The matrix web is thereafter densified.

According to still another aspect of the invention, a surface cleaning pad comprises a unitized airlaid composite body having a proximal zone defining a cleaning surface configured for contact with the surface to be cleaned and a distal zone adjacent the proximal zone on a side opposite the cleaning surface. The proximal zone occupies a portion of the unitized airlaid composite body and the proximal zone comprises bonding fiber material. The distal zone occupies another portion of the thickness of the unitized airlaid composite body, and the distal zone comprises bonding fiber material, wherein the concentration by weight of the bonding fiber material in the proximal zone is greater than a concentration by weight of the bonding fiber material in the distal zone. The surface cleaning pad further comprises means for attaching the unitized airlaid composite body to a cleaning implement.

### BRIEF DESCRIPTION OF THE DRAWINGS

Exemplary embodiments of the invention will be described with reference to the drawings, of which:

FIG. 1 is a bottom view of an absorbent cleaning pad in accordance with an exemplary embodiment of the present invention;

FIG. 2 is a right side view of the absorbent cleaning pad illustrated in FIG. 1;

FIG. 3 is an end view of the absorbent cleaning pad illustrated in FIG. 1;

FIG. 4 is a top view of the absorbent cleaning pad illustrated in FIG. 1, including a cut-away portion of the cleaning pad;

FIG. 5a is a cross-sectional partial end view of an embodiment of a unitized airlaid composite suitable for use in the absorbent cleaning pad illustrated in FIG. 1;

FIG. 5b is a cross-sectional partial end view of another embodiment of a unitized airlaid composite suitable for use in the absorbent cleaning pad illustrated in FIG. 1;

FIG. 6 is a schematic, perspective view of an embodiment of a system that can be used to form an absorbent cleaning pad according to an aspect of this invention;

FIG. 7 is a schematic, sectional side view of the system illustrated in FIG. 6; and

FIG. 8 is a flow chart illustrating exemplary steps of a process for forming an absorbent cleaning pad according to another aspect of the invention.

FIGS. 9 through 19 are schematic representations of exemplary systems that can be used to form a unitized airlaid composite according to aspects of this invention.

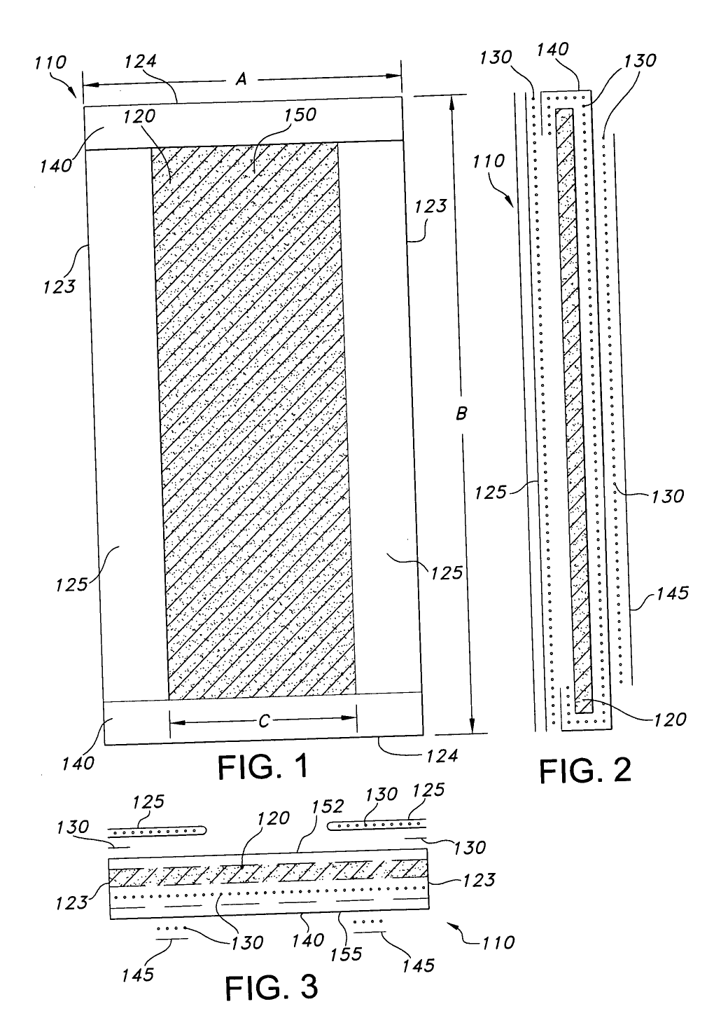

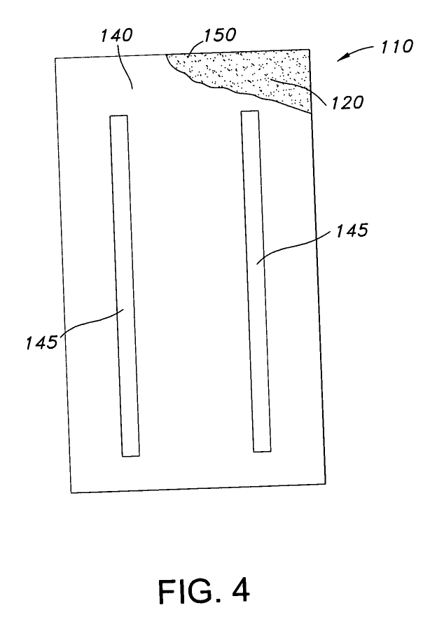

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention. Also, the embodiments selected for illustration in the figures are not shown to scale and are not limited to the proportions shown.

As used herein, the term “nonwoven web” defines a web having a structure of individual fibers which are interlaid, but not in an ordered or identifiable manner such as in a woven or knitted web. As defined by INDA, a trade association representing the nonwoven fabrics industry, nonwoven fabrics are generally sheet or web structures bonded together by entangling fiber or filaments (and by perforating films) mechanically, thermally or chemically.

Nonwoven webs are formed from many processes, such as, for example, air-laying processes, meltblowing processes, spunbonding processes, coforming processes and bonded carded web processes. The term “airlaid composite” implies that a non-woven web is formed by an air-laying process.

As used herein, the term “bi-component fiber” or “multi-component fiber” refers to a fiber having multiple components such as fibers comprising a core composed of one material (such as a polymer) that is encased within a sheath composed of a different material (such as another polymer or a thermoplastic polymer). Some types of “bi-component” or “multi-component” fibers can be used as binder fibers that can be bound to one another to form a unitized structure. For example, in a polymeric fiber, the polymer comprising the sheath often melts at a different, typically lower, temperature than the polymer comprising the core. As a result, such binder fibers provide thermal bonding due to melting of the sheath polymer, while retaining the desirable strength and fibrous structure characteristics of the core polymer. As an alternative to using a binder fiber, fibers are optionally spunbound or otherwise formed into a nonwoven structure.

As used herein, the term “concentration by weight” is defined as the ratio of the weight of one component (e.g. binder fibers) within a structure or a portion of a structure to the weight of all components (e.g. binder fibers and non-binder fibers) within the structure or the portion of the structure. In other words, the concentration by weight of a component is the weight ratio of that component to all components.

Referring to the overall structure of one exemplary embodiment, FIGS. 1 thru 5a illustrate an absorbent cleaning pad designated generally by the numeral “110”. Generally, the absorbent cleaning pad 110 has a pad body formed from a unitized airlaid composite and having a cleaning surface configured for cleaning contact with a surface to be cleaned and an opposite surface configured to be positioned facing a cleaning implement. The surface cleaning pad also has a backing (e.g., film or fabric) adhered to and substantially covering the opposite surface of the pad body and a pair of lofty cuffs adhered to the cleaning surface of the pad body.

As an alternative to applying a backing to a surface of the pad body in the form of a separate component adhered to (or otherwise associated with) the pad body, a backing is optionally provided by chemically, mechanically, or thermally modifying a surface of the pad body. For example, an agent is optionally applied to the pad body to provide a backing function. In such an embodiment, an agent (e.g., a fluoro-chemical compound or a sizing agent or an suitable waterproofing agent) is optionally sprayed, coated, or otherwise applied to a surface of the pad body. Alternatively, a layer of hydrophobic fibers or nonwoven can be used to provide a backing function.

An applied agent can provide a surface (or a portion of a surface) of the pad body with selected characteristics. For example, the surface or surface portion can be rendered hydrophobic (to resist or prevent the passage of fluid) or hydrophilic (to encourage or promote the passage of fluid) through the surface or surface portion. In one use, the agent renders a surface of the pad body hydrophobic to prevent liquid from passing from within the pad body through the surface. Such a surface is particularly advantageous for surfaces of a cleaning pad that face toward a cleaning implement to which it is attached.

More specifically, and according to one embodiment, the exemplary absorbent cleaning pad 110 or cleaning sheet is provided with a unitized airlaid composite 120, supplementary dirt entrapment surfaces in the form of two lofty cuffs 125, a backing layer 140, and two attachment members 145. Each lofty cuff 125 is folded into two equal segments and positioned along the length “B” of the unitized airlaid composite 120 although each cuff is alternatively formed from a single layer of material. Additional benefits and features of such cuffs are disclosed in U.S. application No. xx/xxx,xxx, filed concurrently herewith (Attorney Docket No. TCO4-129US). A portion of the width of each lofty cuff 125 is bonded to a cleaning surface or side 152 of the unitized airlaid composite 120 using an adhesive 130. The backing layer 140 is adhered to the attachment surface or side 155 of the unitized airlaid composite 120 using an adhesive 130 and folded around the width-wise sides 124 of the unitized airlaid composite 120, thereby enclosing the width-wise sides 124. As discussed previously, the backing layer 140 is optionally eliminated, and the function of the backing layer 140 can alternatively be eliminated or provided by applying an agent directly to a surface or a surface portion of the pad body or by otherwise chemically, mechanically, or thermally modifying the surface of the pad body.

The unitized airlaid composite 120 of the exemplary embodiment absorbs and retains fluids and/or other matter residing on a soiled surface and maintains the structural integrity of the cleaning pad 110 during use. Although the cleaning pad body of the exemplary embodiment is formed from a unitized airlaid composite 120, the cleaning pad body may be formed from many processes, such as, for example, meltblowing processes, spunbonding processes, foaming processes, coforming processes and bonded carded web processes. Accordingly, the cleaning pad body is not limited to a unitized airlaid composite or air-laying process.

Nevertheless, it has been discovered that the optional use of a unitized airlaid composite to form the cleaning pad body confers numerous, significant advantages. These advantages are especially significant when the cleaning pad body is formed from an airlaid composite suitable for direct contact with the surface to be cleaned according to aspects of this invention (e.g., without the need for a layer of material interposed between a surface of the airlaid composite and the surface to be cleaned).

For example, it has been discovered that by using a unitized airlaid structure for the pad body, in such a way as to eliminate the need for a layer interposed between the airlaid composite and the surface to be cleaned (i.e., wherein a surface of the airlaid composite is exposed in the final product), the expense and complexity associated with converting processes can be reduced. More specifically, it has been recognized that cost and complexity are introduced when layers of different materials need to be assembled during the process of converting raw materials into a finished product. Such assembly requires machinery that is configured to synchronize the positioning of webs of components as they travel continuously along a machine direction. Also, it has been recognized that processes for converting such raw materials into a final product are complicated by the fact that raw materials have different strength and stretch characteristics. Accordingly, reducing the number of raw materials that need to come together to form a finished product in the converting process (or perhaps even eliminating the need to assemble any components) sharply reduces the cost and complexity associated with converting processes.

Additionally, it has been discovered that the utilization of a unitized airlaid construction, without supplemental surface-contacting layers preventing contact between the airlaid composite and a surface to be cleaned, also reduces raw material costs. Because raw materials are often supplied by different companies and may need to be cut to particular specifications, there is often a waste of material associated with the procurement of such materials for use in converting processes. Also, when such materials are purchased from various suppliers or vendors, the overhead (and margin) associated with such suppliers and vendors are added to the cost of the final product.

Additionally, it has been discovered that the use of laminations bonded together to form a cleaning pad structure introduces extra cost associated with such lamination materials. More specifically, such laminations may require additional raw materials. Accordingly, the elimination of supplemental layers such as laminations has been discovered to reduce the cost associated with the cleaning pad product.

The lofty cuffs 125 serve to facilitate the removal of larger soils from the surface being cleaned by contacting and trapping the soil particles. The lofty cuffs 125 typically trap soil particles (e.g., dog hair and similar objects) that are too large for the airlaid composite 120 to trap.

The backing layer 140 substantially prevents fluid from passing from the unitized airlaid composite 120 to a cleaning implement to which it is attached, to maintain an unsoiled cleaning implement. The backing layer 140 also substantially limits airlaid composite absorbent particles from escaping out of the exposed width-wise sides 124 of the unitized airlaid composite 120.

The attachment members 145 provide an attachment mechanism to temporarily couple the absorbent cleaning pad 110 to a floor cleaning implement, for example. Additional benefits and features of attachment mechanisms are disclosed in U.S. application Ser. Nos. xx/xxx,xxx and xx/xxx,xxx, filed concurrently herewith (Attorney Docket Nos. TCO4-115US and TCO4-122US). The disclosure of U.S. application Ser. Nos. xx/xxx,xxx and xx/xxx,xxx are incorporated herein by reference in their entirety.

Referring still to FIGS. 1 thru 5a, the cleaning sheet of the exemplary embodiment is formed from a unitized airlaid nonwoven composite. The airlaid nonwoven is a highly absorbent, lofty fabric or composite that is relatively cost competitive with similar weight nonwovens. The airlaid composite is composed of at least binder fibers and absorbent components such as cellulosic fibers and/or superabsorbent particles which are suspended in a web-like arrangement. Other additional materials (e.g., emulsion polymer bonding systems, hotmelt, powder) are optionally present, and components of the airlaid may be needled or hydroentangled. The exemplary airlaid composite 120 is a singular unitized body providing a cleaning surface or side 152 that is in direct contact with the soiled surface and an opposing attachment surface or side 155 of the absorbent cleaning pad 110 in contact with the cleaning implement (not shown). By way of non-limiting example, and for purposes of illustration only, the unitized airlaid composite 120 of the exemplary embodiment is optionally provided with a squeeze-out value of approximately 50% and an absorbent capacity of at least approximately 28 grams/gram, although higher or lower values for squeeze-out and absorbent capacity are contemplated as well. The squeeze-out value is the cleaning pad's capacity to retain absorbed fluid, even during the pressures exerted during the cleaning process. However, a certain amount of fluid is advantageously released during use in order to efficiently clean a surface such as a floor. A test method for determining squeeze-out value is provide in U.S. Patent No. 6,601,261, to Holt et al.

The unitized airlaid composite 120 is optionally capable of retaining 350 grams of de-ionized water. As will be described in further detail below, the use of a unitized airlaid composite structure to form the pad body of a cleaning pad advantageously allows for better control of squeeze-out value. In other words, the structure and composition of the unitized airlaid can be modified in such a way as to increase or decrease squeeze-out value and to render squeeze-out value more predictable. This is particularly advantageous when, according to aspects of this invention, the cleaning pad does not include a layer of material between the pad body and the surface to be cleaned (i.e., where an exposed surface of the pad body is configured for direct contact with a surface to be cleaned).

The unitized airlaid composite 120 of the exemplary embodiment is substantially rectangular in shape having a length B and width A. However, the shape of the unitized airlaid composite 120 is not limited to a rectangular shape, as the unitized airlaid composite may comprise any shape or form.

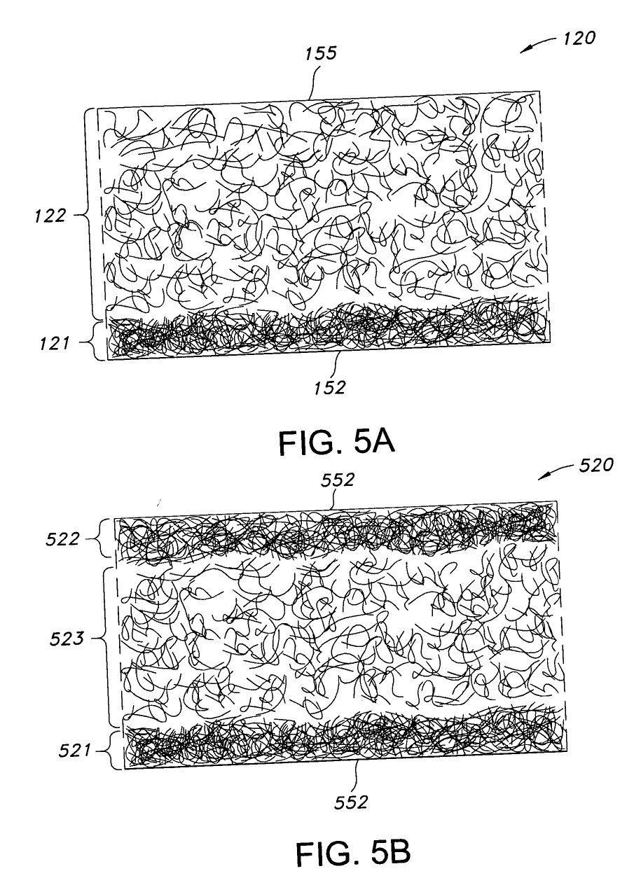

Referring to FIG. 5a specifically, a cross-sectional detailed view of the unitized airlaid composite 120 of the exemplary embodiment is illustrated. The unitized airlaid composite 120 includes two or more zones, i.e. a proximal zone 121 (located proximal to and defining the cleaning side 152) and a distal zone 122 (located distal from the cleaning side 152 but adjacent to proximal zone 121 on a side opposite the cleaning side 152). The proximal zone 121 comprises binder fibers (e.g. bi-component fibers) and the distal zone 122 comprises both binder fibers and non-binder fibers such as absorbent components (e.g. cellulosic fibers and/or super absorbent particles). The concentration by weight and/or the density of binder fiber material in the proximal zone 121 is preferably, but not always, greater than the concentration by weight and/or the density of binder fiber material in the distal zone 122.

The proximal zone 121 is contiguous with (and defines) the cleaning side 152 of the unitized airlaid composite 120 that is in contact with the soiled surface in use. Accordingly, the proximal zone 121 is composed of a material sufficiently durable such that the proximal zone 121 retains its integrity during cleaning and abrading actions against the soiled surface. This characteristic of the unitized airlaid composite 120 is particularly advantageous when, according to aspects of this invention, an exposed surface of the pad body is positioned for direct contact with a surface to be cleaned. Additionally, when the proximal zone 121 is provided with the integrity needed to withstand direct contact with the surface to be cleaned, the cleaning pad can be provided with improved integrity or can be provided with comparable integrity (as compared to conventional products) with less material (e.g., by means of the elimination of any layer interposed between the pad body and the surface to be cleaned, by the utilization of less material, etc.).

The proximal zone 121 interacts with the soil as it passes over the soiled surface, loosening and emulsifying tough soils and permitting them to pass freely into the distal zone 122 of the pad. The proximal zone 121 can facilitate other functions, such as polishing, dusting, scraping, and buffing a surface. In addition to interacting with the soiled surface, the proximal zone 121 also serves as a fluid acquisition zone that delivers fluid to the distal zone 122 of the unitized airlaid composite 120.

The distal zone 122 is contiguous with and defines the attachment side 155 of the unitized airlaid composite 120 that is in contact with the cleaning implement (not shown). The distal zone 122 facilitates the storage of clean and/or soiled liquid as well as cleaning solution removed from the surface being cleaned. The distal zone 122 also filters and traps the dirt particles in the soiled liquid. In addition to storing and filtering liquid, the distal zone 122 facilitates the release of the stored liquid. Accordingly, the dirt particles are retained within the distal zone 122 after the liquid is released from the distal zone 122. Additionally, as discussed previously, the squeeze-out value of the cleaning pad is optionally controlled to retain a sufficient amount of liquid.

The proximal zone 121 may represent approximately five to approximately fifty percent or more of the entire thickness of the unitized airlaid composite 120. In composite 120, the proximal zone 121 extends from the exterior cleaning surface or side 152 to a depth spaced from side 152. The distal zone 122 extends from the proximal zone 121 to the attachment surface or side 155 of the composite 120. The zones 121 and 122 are integral with one another by virtue of the process used to form the composite 120, described in greater detail hereafter.

The unitized airlaid composite 120 is composed of at least binder fibers and absorbent matter such as fluff pulp and a super absorbent polymer (SAP). The relationship between the concentration by weight of binder fibers and the concentration by weight of absorbent matter has an impact upon the tensile strength and the absorbency of the unitized airlaid composite 120. As used herein, the term “tensile strength” is defined as the amount of force a fiber or material web can withstand before breaking or permanently deforming. Prior to breaking or permanently deforming, the fiber or material web may elastically deform.

The web tensile strength is substantially linearly proportional to the concentration by weight of binder fibers in the unitized airlaid structure. Hence, as the percentage by weight of binder fibers increases relative to the percentage by weight of absorbent matter in a particular portion of the composite, the tensile strength of the unitized airlaid composite increases in that portion. However, it should be noted that as the percentage by weight of binder fibers increases in a particular portion, the concentration by weight of absorbent matter decreases, thereby reducing the absorbency of the unitized airlaid composite 120 in that portion. The graph below illustrates the relationship between the unitized airlaid web tensile strength and the percentage of binder fibers within the unitized airlaid structure.

[image]

### Airlald Web Tensile Strength Vs. Binder Fiber Percentage

In addition to tensile strength, it has been discovered that an advantageous characteristic of an airlaid composite used in a pad body of a cleaning pad according to aspects of the invention is that the airlaid composite will have sufficient tear strength to withstand the forces encountered during the cleaning process, which may include scraping and other vigorous actions under pressure. For example, for embodiments in which the cleaning surface of the cleaning pad is an exposed surface of airlaid composite, the airlaid composite should be able to withstand forces encountered with rough or irregular cleaning surfaces without tearing. It is recognized that surfaces to be cleaned (e.g., floors, walls, and other similar surfaces) may include surface features capable of engaging selected portions of the cleaning pad. If, for example, the head of a nail or screw or staple protrudes from a surface to be cleaned, that surface feature may engage the cleaning pad while a force of continued movement is applied to the cleaning pad, thereby encouraging a tear in the pad and/or possible linting from zones of the pad exposed by such a tear.

It has further been discovered that, while maintaining a sufficient tensile strength and a sufficient tear resistance as described in further detail below, it is also advantageous to maintain a reduced coefficient of friction between the exposed surfaces of the cleaning pad and the surface to be cleaned. In other words, the friction encountered when the cleaning pad is moved in sliding relationship with a surface to be cleaned is advantageously maintained at an acceptable level in order to facilitate comfortable use of the cleaning pad. If the coefficient of friction between the cleaning pad and the surface to be cleaned becomes too great, the effort needed to slide the cleaning pad with respect to the surface to be cleaned may become unacceptable to users of the cleaning pad. The problems associated with an excessive coefficient of friction are exacerbated when a user of such a pad presses hard to remove stubborn dirt deposits. Details with respect to this coefficient of friction will be described later in greater detail.

The foregoing characteristics of tensile strength, tear resistance, and coefficient of friction have been discovered to compete with one another. It is believed that articles, such as airlaid composites, having increased tensile strength and tear resistance often have an increased coefficient of friction, while materials having a reduced coefficient of friction may have compromised tensile strength and tear resistance properties. Accordingly, it has been discovered that a cleaning pad having a cleaning surface at least partially defined by an exposed region of a unitized airlaid composite preferably balances the characteristics of tensile strength, tear resistance, and coefficient of friction.

According to the exemplary embodiment, to achieve a greater concentration by weight of binder fibers in the proximal zone 121, the air-laying apparatus is configured to distribute a greater concentration by weight of binder fibers at the proximal zone 121, as compared to the distal zone 122. In another embodiment, the binder fibers of the proximal zone 121 may be compacted or densified to increase the density of the proximal zone 121. In yet another embodiment, the individual binder fibers of the proximal zone 121 may have a higher basis weight than the binder fibers of the distal zone 122, as binder fibers of higher basis weight typically exhibit greater tensile strength. These exemplary embodiments will be described in further detail with reference to the airlaid fabrication process.

In the exemplary embodiment illustrated in FIG. 5a, the web of binder fibers in the proximal zone 121 is of greater concentration by weight than the web of binder fibers in the distal zone 122. It has been discovered that a proximal zone 121 comprising at least a fifty percent greater concentration by weight of binder fibers than the distal zone 122 improves the durability of the unitized airlaid composite. It has also been discovered that a proximal zone 121 comprising at least a one hundred percent greater concentration by weight of binder fibers than the distal zone 122 further improves the durability of the unitized airlaid composite.

For example, the composite 120 may have a concentration by weight of binder fibers of X % in the distal zone 122 and a concentration by weight of binder fibers in the proximal zone 121 of at least about 1 ½ X %, or more preferably at least about 2X %, more preferably at least about 3X %, and most preferably at least about 4X %. The concentrations by weight of binder fibers in the proximal and distal zones are selected depending on the desired tensile characteristics of the composite and other design considerations.

Cellulosic fibers and superabsorbent polymer (SAP) particles 150 provide the unitized airlaid composite 120 with absorbency and fluid storage capacity. The SAP particles and cellulosic fibers may either be disbursed throughout the entire airlaid composite 120 or the distal zone 122 of the unitized airlaid composite 120. The SAP particles, in particular, are optionally zoned in a region of the unitized airlaid composite 120. Benefits and features of zoned super absorbent particles and additional absorbent matter are disclosed in U.S. application Ser. No. xx/xxx,xxx, filed concurrently herewith (Attorney Docket No. TC04-119US), the disclosure of which is incorporated herein by reference.

Regarding the composition of the exemplary embodiment of the nonwoven airlaid composite 120, the binder fibers comprising the unitized airlaid composite 120 are bi-component fibers. Bi-component fibers maintain their fibrous nature after bonding and are easily dispersed throughout the airlaid structure, including the z-direction. The resulting airlaid composite is a soft structure with superior wet resilience and strength.

The bi-component fibers within the unitized airlaid composite 120 influence the airlaid composite's wet and dry tensile strength. The variables which most significantly impact airlaid composite web tensile strength are bi-component concentration, bi-component fiber denier, bi-component fiber length, bi-component fiber basis weight, the percentage ratio and configuration of core to sheath components of the fiber, and orientation of the bi-component fiber within the airlaid composite. By way of non-limiting example, the denier of the bi-component fiber is optionally up to approximately 4, but more preferably less than about 3, although fibers of higher and lower denier are contemplated as well. According to one exemplary embodiment, a denier of about 1½ or less is optionally selected. For example, fibers having a denier of 1.55 are preferred according to one exemplary embodiment of the invention. The length of the bi-component fiber is approximately four to approximately six millimeters, although longer and shorter fibers are optionally selected. The basis weight of the bi-component fiber as a percentage of the basis weight of the entire airlaid composite is approximately 10% to approximately 50%, but more preferably about 15% to about 25%.

Although the binder fibers of the exemplary embodiment are bi-component fibers, the invention is not limited to bi-component fibers. The binder fibers can be mono-component or multi-component. The binder fibers can comprise solely naturally occurring fibers, solely synthetic fibers, or any compatible combination of naturally occurring and synthetic fibers. The fibers useful herein can be hydrophilic, hydrophobic or can be a combination of both hydrophilic and hydrophobic fibers. Suitable hydrophilic fibers for use in the present invention include cellulosic fibers, modified cellulosic fibers, cellulose acetate, rayon, polyester fibers, and other fibers such as hydrophilic nylon. Suitable hydrophilic fibers can also be obtained by hydrophilizing hydrophobic fibers, such as surfactant-treated or silica-treated thermoplastic fibers derived from, for example, polyolefins such as polyethylene or polypropylene and polyesters.

Referring to FIG. 5b, another exemplary embodiment of the unitized airlaid composite 520 is illustrated. The airlaid composite 520 includes three zones. This exemplary embodiment provides two cleaning sides 552, located on opposing sides of the airlaid composite 520. This exemplary embodiment permits the utilization of both sides of the airlaid composite 520. After one side of the unitized airlaid composite has significantly deteriorated, for example, the user can flip the airlaid composite 520 over to employ the opposing unused side of the airlaid composite.

The unitized airlaid composite 520 includes two proximal zones 521 and 522 and one distal zone 523. The proximal zones 521, 522 comprise binder fibers (e,g, bi-component fibers) and the distal zone 523 comprises both binder fibers and absorbent components (e.g. cellulosic fibers and/or super absorbent particles). However, the proximal zones 521, 522 may also contain absorbent components in another embodiment. Although the thickness of the two proximal zones 521, 522 are shown substantially equivalent, the embodiment is not limited to the selected illustration, as one proximal zone may be thicker than the other and/or contain different concentrations of fibers.

The composition and structure of several exemplary unitized air laid composites are summarized in the following table:

| | Components (gsm) | | | | Tensile | Tear |
|---|---|---|---|---|---|---|
| Zone | Fiber | Pulp | SAP | Total | Strength | Resistance |

Sample 1 (Roll 10-HIGH CAPACITY)

| | | | | | | |
|---|---|---|---|---|---|---|
| 1 | 50 | 0 | 0 | 50 | 9538 | 1044.4 |
| 2 | 12.1 | 76 | 10.8 | 98.9 | | (MD) |
| 3 | 12.1 | 76 | 10.8 | 98.9 | | 1064.8 |
| 4 | 12.1 | 76 | 10.8 | 98.9 | | (CD) |
| Totals | 86.3 | 228 | 32.4 | 346.7 | | |

Sample 2 (Roll 12-LOW CAPACITY)

| | | | | | | |
|---|---|---|---|---|---|---|
| 1 | 40 | 0 | 0 | 40 | 6411.5 | 754.5 (MD) |
| 2 | 8.1 | 50.6 | 1.3 | 60 | | 766.5 (CD) |
| 3 | 8.1 | 50.6 | 1.3 | 60 | | |
| Totals | 56.2 | 101.2 | 2.6 | 160 | | |

Sample 3 (Roll 8-HIGH CAPACITY)

| | | | | | | |
|---|---|---|---|---|---|---|
| 1 | 50 | 0 | 0 | 50 | 9608 | 1244.3 |
| 2 | 12.5 | 77 | 10 | 99.5 | | (MD) |
| 3 | 12.5 | 77 | 10 | 99.5 | | 1092.6 |
| 4 | 12.5 | 77 | 10 | 99.5 | | (CD) |
| Totals | 87.5 | 231 | 30 | 348.5 | | |

Sample 4 (Roll 14-LOW CAPACITY)

| | | | | | | |
|---|---|---|---|---|---|---|
| 1 | 25 | 0 | 0 | 25 | 4393.4 | 599.5 (MD) |
| 2 | 0 | 0 | 0 | 0 | | 578.3 (CD) |
| 3 | 9.1 | 57.1 | 1.3 | 67.5 | | |
| 4 | 9.1 | 57.1 | 1.3 | 67.5 | | |
| Totals | 43.2 | 114.2 | 2.6 | 160 | | |

Sample 5 (Roll 3-LOW CAPACITY)

| | | | | | | |
|---|---|---|---|---|---|---|
| 1 | 30 | 0 | 0 | 30 | 8346.5 | 840.7 (MD) |
| 2 | 30 | 0 | 0 | 30 | | 812.7 (CD) |
| 3 | 3.3 | 20.7 | 9.33 | 33.33 | | |
| 4 | 3.3 | 20.7 | 9.33 | 33.33 | | |
| Totals | 3.3 | 20.7 | 9.33 | 33.33 | | |

The samples (S1 to S5) summarized in the foregoing table are unitized airlaid composites each having a plurality of zones that together define the thickness of the composite. Each of the Samples 1 to 5 have a zone (Zone 1) that is configured to be positioned away from a head of a cleaning implement (if the cleaning pad is used in conjunction with a cleaning implement) or away from the user's hand (if the cleaning pad is to be used by hand). The proximal zone, Zone 1 (and sometimes including Zone 2), is the zone that defines at least a portion of the cleaning surface of the cleaning pad. Zone 1 therefore defines the surface of the unitized airlaid composite that is exposed for direct contact with the surface to be cleaned.

The remaining zones (Zones 2-4 of Sample 1, for example) are progessively spaced from the cleaning surface of the cleaning pad. Each of the zones of the respective samples represent a portion extending across a partial thickness of the unitized airlaid composite. Each of these zones are portions or parts of an integral, unitized construction.

Referring specifically to Sample 1 for the purpose of illustration, the unitized airlaid composite of that sample includes four (4) zones (Zones 1-4), each of which includes one or more constituents or components. The amount of each component in each of Zones 1-4 is provided in terms of the grams per square meter (gsm) of that component of the resulting unitized airlaid composite. For example, Zone 1 of Sample 1 includes 50 gsm of a bonding fiber, 0 gsm of pulp, and 0 gsm of super absorbent polymer (SAP), thereby providing a total of 50 gsm for Zone 1. In Sample 1, the composition of Zones 2-4 are the same, each having the same amount of bonding fibers (12.1 gsm), pulp (76 gsm), and SAP (10.8 gsm), resulting in a total of 98.9 gsm for each of the Zones 2-4. The total for the entire unitized airlaid composite of Sample 1 is therefore 346.7 gsm. In part because of the composition of SAP in Sample 1, the total capacity to absorb liquid is significant for Sample 1.

It will be noted that Sample 1 has a greater amount of bonding fibers in Zone 1 (the zone that at least partially defines the cleaning surface of the cleaning pad) as compared to Zones 2-4. In fact, the ratio of bonding fibers in Zone 1 to the amount of bonding fibers in each of Zones 2-4 is over 4:1.

Referring to the components of Sample 2, Sample 2 has a Zone 1 (at least partially defining the cleaning surface of the cleaning pad) having 40 gsm of bonding fibers and no pulp and no SAP, thereby providing Zone 1 with a total of 40 gsm. Zones 2 and 3 are substantially identical in that they both have 8.1 gsm of bonding fibers, 50.6 gsm of pulp, and 1.3 gsm of SAP, each therefore having a total basis weight of 60 gsm. The airlaid composite of Sample 2 therefore has a total basis weight of 160 gsm, and Sample 2 will therefore be expected to have a lower capacity as compared to Sample 1 because of the reduced quantity of SAP (and pulp).

As indicated in the foregoing table and mentioned previously, several of the samples have lower total basis weights while others have higher total basis weights. For example, Samples 1 and 3 have basis weights of about 350 gsm. Such samples can be considered to have a higher capacity. Other samples, for example Samples 2, 4, and 5, have a total basis weight of about 160 gsm and therefore would be expected to have a significantly lower capacity.

Lower capacity unitized airlaid composites preferably exhibit a tensile strength of at least about 2000 grams force (gf), more preferably at least about 3500 gf. The higher capacity unitized airlaid composites preferably have a tensile strength of at least about 5000 gf, more preferably at least about 6500 gf.

Regarding tear strength, lower capacity unitized airlaid composites preferably have a tear strength exceeding about 300 gf, more preferably more than about 500 gf. The higher absorbent capacity unitized airlaid composites preferably have a tear strength exceeding about 800 gf, more preferably exceeding about 1000 gf.

The tensile strength tests reported in the foregoing table were conducted using a tensile test device provided by Instron Corporation of Norwood, Mass. The test was conducted according to the following procedures:

(1) cut airlaid tensile samples at 1 inch wide, 6 inch length;

(2) utilize the Instron Series IX Automated Materials Testing System with the following settings:
(a) 2 inch width distance,
(b) 12 inch cross head speed,
(c) 5.000 (kgf) full scale load range, and
(d) test method Airlaid Tensile 71.

For the tear resistance test, the following procedure is used:

(1) cut airlaid tear samples at 2 inch width, 7 inch length;

(2) use the Instron Series IX automated materials testing system with the following settings:
(a) 1 inch width distance,
(b) 20 inch cross head speed,
(c) 5.000 (kgf) full scale load range, and
(d) Test Method 28 Airlaid Tear.

The following table provides the results of testing performed to determine the coefficient of friction of Sample 1, both in a dry state and in a wet state (wet with deionized water):

| | | | | |
|---|---|---|---|---|
| | | Force | | |
| | Force | Reading | | |
| | Reading | (After | Friction | |
| | (Final) | Zeroing) | (669 g | Coefficient |
| Test | (gf) | (gf) | Load) | of Friction |

Dry

| | | | | |
|---|---|---|---|---|
| 1 | 117.9 | 3 | 114.9 | 0.17 |
| 2 | 107.8 | 7 | 100.8 | 0.15 |
| 3 | 106.5 | 2.8 | 103.7 | 0.16 |
| 4 | 108.3 | 4.9 | 103.4 | 0.15 |
| 5 | 102.3 | 4.6 | 97.7 | 0.15 |
| 6 | 101.7 | 1.7 | 100 | 0.15 |
| 7 | 98.1 | 3.4 | 94.7 | 0.14 |
| 8 | 93.6 | 4.8 | 88.8 | 0.13 |
| 9 | 96.3 | 0.2 | 96.1 | 0.14 |
| 10 | 96.2 | 0.2 | 96 | 0.14 |
| | | Average | 99.61 | 0.15 |
| | | St Dev | 6.96 | 0.01 |

Wet (Deionized Water)

| | | | | |
|---|---|---|---|---|
| 1 | 93.8 | 1.6 | 92.2 | 0.14 |
| 2 | 97.8 | 4.8 | 93 | 0.14 |
| 3 | 85.7 | 2.4 | 83.3 | 0.12 |
| 4 | 98.7 | 3.6 | 95.1 | 0.14 |
| 5 | 77.4 | 3.2 | 74.2 | 0.11 |
| 6 | 80.2 | 2.8 | 77.4 | 0.12 |
| 7 | 86.2 | 4.4 | 81.8 | 0.12 |
| 8 | 79.4 | 4.9 | 74.5 | 0.11 |
| 9 | 68.8 | 3.1 | 65.7 | 0.10 |
| 10 | 80.5 | 5.5 | 75 | 0.11 |
| | | Average | 81.22 | 0.12 |
| | | St Dev | 9.69 | 0.01 |

Referring to the foregoing table, Sample 1 has an average, low coefficient of friction when dry of about 0.15. When wet with deionized water, Sample 1 has an average, low coefficient of friction of about 0.12.

As described previously, it is advantageous to maintain a reduced coefficient of friction between the exposed surfaces of the cleaning pad and the surface to be cleaned. This feature helps to manage the effort needed to slide the cleaning pad with respect to the surface to be cleaned, especially when a user of such a pad presses hard to remove stubborn dirt deposits. Accordingly, it has been discovered to be advantageous, pursuant to one aspect of this invention, to configure the cleaning surface of the unitized airlaid composite in such a way as to maintain an average dry coefficient of friction below about 2.5, more preferably below about 2.0, and most preferably about 1.5 or less. It has been discovered to be advantageous to maintain an average wet coefficient of friction below about 2.0, more preferably below about 1.5, and most preferably about 1.2 or less.

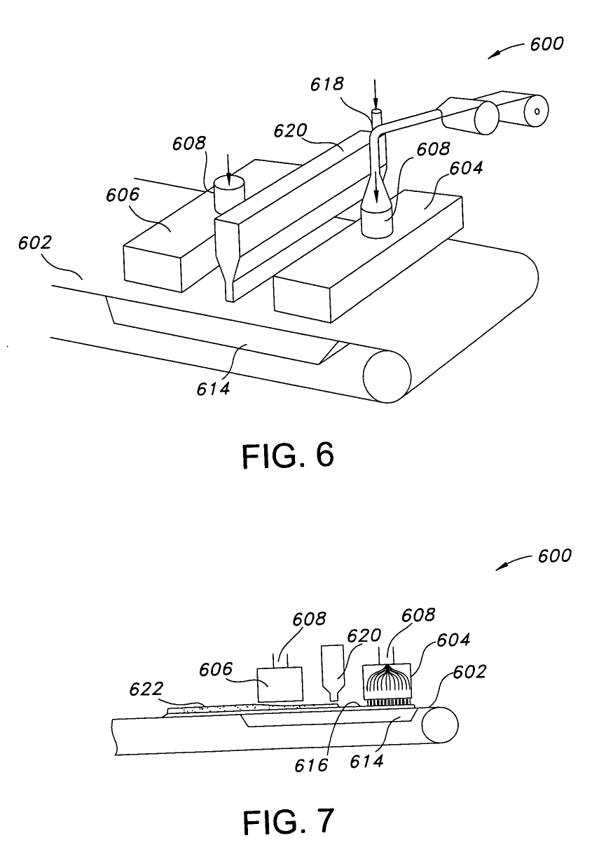

FIGS. 6 and 7 schematically show an example of an airlaid composite forming system 600 that can be used to form an absorbent cleaning pad according to one aspect of the invention if the pad includes a unitized airlaid composite. It is also contemplated that the absorbent cleaning pad is formed with an alternative structure, including any fibrous or non-fibrous material capable of defining a substrate.

Forming heads 604 and 606 each receives a flow of an air fluidized fiber material (e.g., binder fibers, wood pulp, other fibrous materials, or combination thereof) via supply channels 608. A suction source 614, mounted beneath the perforated moving wire 602, draws air downwardly through the perforated moving wire 602. In one embodiment, the binder fiber material is distributed and compacted (by the air flow and/or a compaction roll) over the width of the wire 602 to form a first portion on the surface of the wire 602. The first portion comprises the proximal zone 121. A second forming head (not shown) is provided to distribute a second portion 616 composed of a mixture of binder fibers and non-binder fibers such as cellulosic fibers onto the first portion. The second portion 616 comprises a segment of the distal zone 122.

The SAP particles are introduced into the particle dispenser 620 through a tube 618. The particle dispenser 620 is configured to direct (e.g., spray, sprinkle, release, etc.) the SAP particles onto the perforated moving wire 602 above the second portion 616. The SAP particles are either distributed over a portion of the width and/or length of the second portion 616 or distributed over the entire second portion 616. The SAP particles blend and disseminate through the second portion 616 and are thereby maintained throughout the entire thickness of the unitized airlaid composite.

A third forming head 606 is provided to distribute a third portion 622 of binder and/or cellulosic fibers over the SAP particles and the second portion 616. The third portion 622 comprises the remaining segment of the distal zone 122. Although only two forming heads are illustrated, more forming heads may be required to distribute additional portions of binder fiber or cellulosic fiber. Thereafter, the portions are heated for a period of time until the binder fibers melt together to form a web-like structure, i.e., a unitized airlaid composite.

In functional terms, the first portion including binder fibers is oriented toward the cleaning surface and provides structure to the unitized airlaid composite. The second portion 616 including binder fibers and cellulosic fibers is maintained over the first portion and provides structure, absorbency (storage) and filtration to the unitized airlaid composite. The SAP particles are maintained over the second portion 616 to provide additional absorbency and filtration to the unitized airlaid composite. The third portion 622 including binder fibers and cellulosic fibers is maintained over the SAP particles and is oriented toward the cleaning implement. The third portion 622 provides structure and absorbency to the unitized airlaid composite. The portions collectively form a unitized airlaid composite according to one embodiment.

Several ways are contemplated to achieve a greater concentration or density of binder fibers within the proximal zone 121 of the airlaid composite 120. In one exemplary embodiment, the proximal zone 121 and the distal zone 122 contain an unequal proportion of binder fibers and absorbency matter (e.g. cellulosic fiber and/or SAP particles). In this embodiment, the forming head(s) are configured to distribute a greater concentration of binder fibers, relative to the concentration of absorbent matter, at the proximal zone 121 relative to the distal zone 122. More specifically, the ratio of binder fibers to absorbent matter is higher within the proximal zone 121 than within the distal zone 122. Accordingly, the proximal zone 121 contains a greater concentration of binder fibers.

In another exemplary embodiment, the forming head(s) are configured to distribute a greater concentration of binder fibers at the proximal zone 121 of the unitized airlaid composite, similar to the previous embodiment. The fibers are subsequently heated for a period of time until the binder fibers melt together to form a unitized airlaid composite 120. To further increase the concentration of binder fibers at the proximal zone 121, the entire formed airlaid composite 120 is compressed. Under an applied compressive load, the binder fibers exhibit greater permanent deformation than the more resilient cellulosic fibers. Accordingly, since the proximal zone 121 maintains a greater concentration of binder fibers, the proximal zone 121 is permanently compacted more than the distal zone 122. In other words, following compaction, the proximal zone 121 exhibits greater permanent deformation than the distal zone 122, by virtue of the relative concentrations of binder fibers and cellulosic fibers within each zone. Therefore, as a result of the compaction process (or other manipulations such as a change in the airflow of the through air dryer), the concentration of binder fibers within the proximal zone 121 is greater than the concentration of binder fibers within the distal zone 122.

In yet another exemplary embodiment, as an alternative to compressing the entire airlaid composite to achieve a greater concentration of binder fibers at the proximal zone 121, the proximal zone 121 may be independently compacted prior to heating the fiber deposits. Generally, as the binder fibers are deposited over the surface of the perforated moving wire 602, gaps are inherently formed between the randomly distributed binder fibers. A compaction roller is positioned to lightly compress the portion of binder fibers, thereby reducing the gaps between the binder fibers and increasing the density of the subsequent web layer. More specifically, in this exemplary embodiment the portion of binder fibers comprising the proximal zone 121 is compacted. Following compaction of the proximal zone 121, a subsequent portion of binder fibers and cellulosic fibers (comprising the distal zone 122) is distributed over the portion of binder fibers comprising the proximal zone 121. The portions are then heated for a period of time until the binder fibers melt together to form a unitized airlaid composite, wherein the density of the proximal zone 121 is greater than the density of the distal zone 122. It should be apparent that compaction roller(s) may be positioned after any one of the forming heads in this embodiment.

In still another exemplary embodiment, to increase the concentration of binder fibers at the proximal zone 121 relative to the concentration of binder fibers at the distal zone 122, the forming heads 604 and 606 distribute binder fibers of different basis weights. Accordingly, the proximal zone 121 includes binder fibers of greater basis weight than the distal zone 122. Therefore, as binder fiber webs of higher basis weight exhibit greater tensile strength, the proximal zone 121 is rendered more durable than the distal zone 122 of the unitized airlaid composite 120.

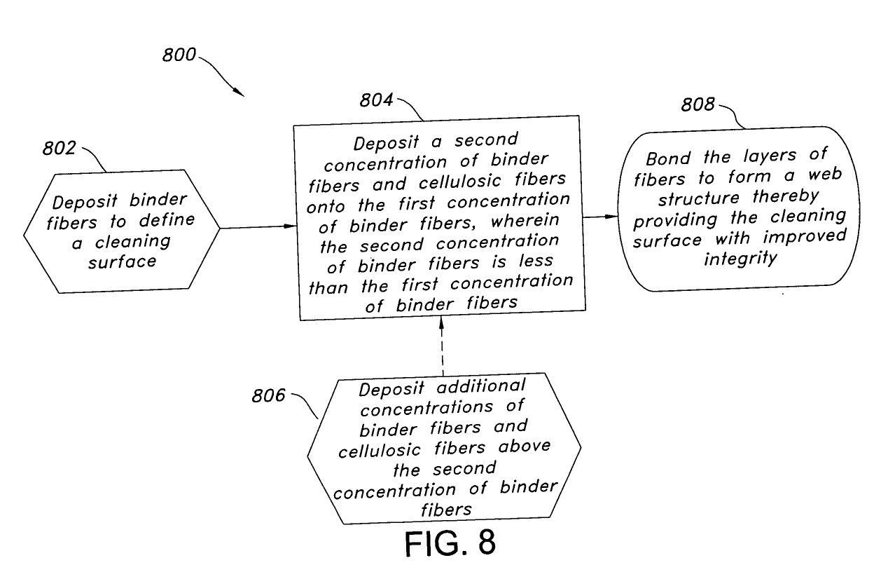

FIG. 8 is a flow chart 800 of exemplary steps for fabricating a unitized airlaid composite in accordance with one embodiment of the present invention. Block 802 illustrates the step of depositing a first concentration of binder fibers so as to define a cleaning surface. Block 804 illustrates the step of depositing a second concentration of binder fibers and cellulosic fibers onto the first concentration of binder fibers, wherein the second concentration of binder fibers is less than the first concentration of binder fibers to form an absorbency and filtration zone. Block 806 illustrates the optional step of depositing an additional concentration of binder fibers and cellulosic fibers onto the second concentration of binder fibers to further construct the absorbency and filtration zone. Block 808 illustrates the final step of bonding the first and second concentrations of binder fibers together to form a web structure, thereby providing a cleaning surface with improved integrity.

The figures described below demonstrate exemplary ways in which compression can be varied using compression rolls positioned between the forming heads. They also illustrate possibilities for incorporating other materials, such as spunbond webs, meltblown webs, or other spunmelt systems into an airlaid system.

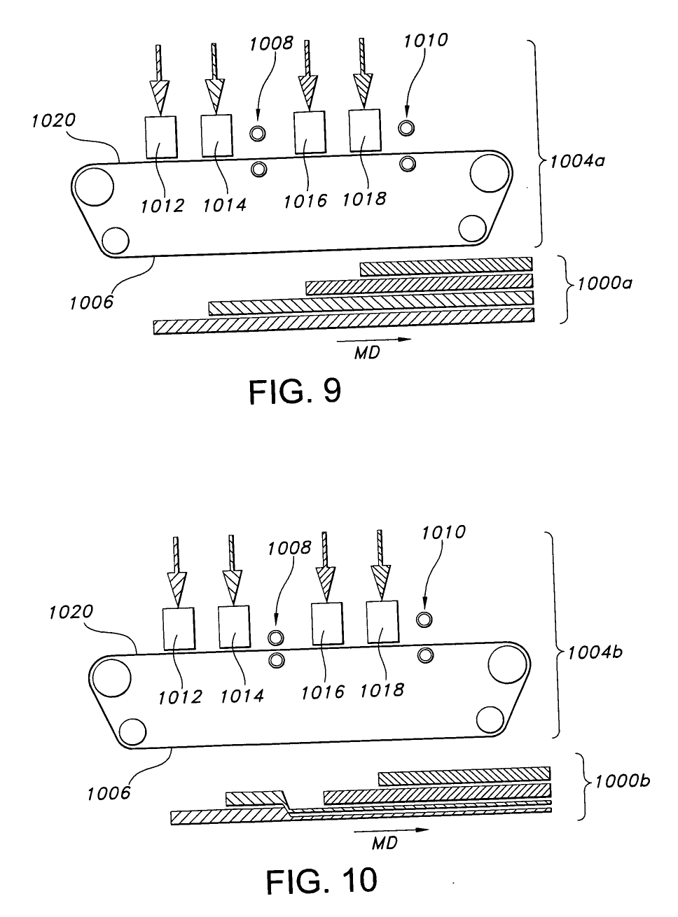

Referring now to FIGS. 9 through 19, schematic representations are provided for exemplary systems that can be used to form a unitized airlaid composite according to aspects of this invention. Specifically, FIGS. 9 through 19 provide side schematic views of exemplary webs and complimentary web-forming systems in such a way as to show how zones of unitized airlaid composites build while moving through respective web-forming systems. The zones of the exemplary webs are not depicted to any particular proportion or scale, but are instead shown schematically for purposes of illustration only. Also, because of the mixing and blending of fibers between the zones of a unitized airlaid structure that occurs during the web-forming process, the zones are not distinct as depicted in the figures but are instead integrated with one another so as to form a cohesive structure.

Generally, each of the web-forming systems illustrated in FIGS. 9 through 19 includes a machine having a conveyor surface including a wire screen on which the web of the airlaid composite is formed. Fiber-introducing heads are positioned above the wire screen in order to deliver components of the airlaid composite to the screen in a controlled manner. The fiber-introducing heads are configured to introduce the same or different fibers in any combination, as depicted schematically in FIGS. 9 through 19 by cross-hatching. For example, two or more or all of the heads can introduce the same fibers or fiber mixture, or all or some of the heads can introduce different fibers or fiber mixtures.

Rolls are also provided in order to selectively modify the web as it passes through the system. The schematic representation of the resulting web of the unitized airlaid composite (juxtaposed below the machine in each of FIGS. 9 through 19) shows the web portions provided by each of the heads as those portions build to form the web of the unitized airlaid composite along the machine direction (MD). Again, the web portions are integrated in actual airlaid systems as opposed to the distinct zones depicted schematically in FIGS. 9 through 19 for purposes of illustration.

Referring specifically to FIG. 9, one exemplary system utilizes a machine 1004a to form a web of an airlaid composite 1000a. The machine 1004a includes a conveyor mechanism 1006 that supports a wire screen 1020 on which the components of the airlaid composites are deposited. A pair of upstream rolls 1008 and a pair of downstream rolls 1010 are provided in such a way that the wire screen 1020 passes between each pair of rolls 1008 and 1010. Plural heads are provided above the wire screen 1020 along the length of the machine 1004a. Specifically, machine 1004a includes four (4) heads, including a first head 1012, a second head 1014, a third head 1016, and a fourth head 1018.

First and second heads 1012 and 1014 are positioned upstream from the upstream rolls 1008, and third and fourth heads 1016, 1018 are positioned downstream from upstream rolls 1008 and upstream from downstream rolls 1010. The upstream and downstream rolls 1008 and 1010 are optionally utilized as compression rolls, and the distance between each pair of rolls 1008 and 1010 is adjustable as will become clear in connection with the description of FIGS. 10 through 19.

The machine 1004a illustrated in FIG. 9 is a 4-head airlaid machine shown to have heads 1012, 1014, 1016 and 1018 feeding substantially equal amounts of the same fiber composition. Alternatively, one or more of heads 1012, 1014, 1016 and 1018 optionally feed substantially different amounts of fibers or feed substantially different fibers or fiber compositions. As illustrated in FIG. 9, the machine 1004a does not utilize upstream and downstream rolls 1008 and 1010 as compression rolls (i.e., the distance between the rolls 1008 and 1010 is maintained so as to eliminate or minimize compression of the web passing between them). Accordingly, the machine 1004a is configured to yield a relatively thick fabric having a substantially constant density.

Referring now to FIG. 10, the exemplary system shown includes a machine 1004b used to form a web 1000b. The machine 1004b is configured to utilize the upstream rolls 1008 as compression rolls while the downstream rolls 1010 are not so utilized. Accordingly, the machine 1004b is configured to form a variable density fabric because the zones introduced by first and second heads 1012 and 1014 are compressed by upstream rolls 1008, thereby increasing the density of those zones, while the zones deposited by third and fourth heads 1016 and 1018 are not densified because the downstream rolls 1010 are spaced so as to minimize or eliminate any compression of the zones deposited by those heads 1016 and 1018.

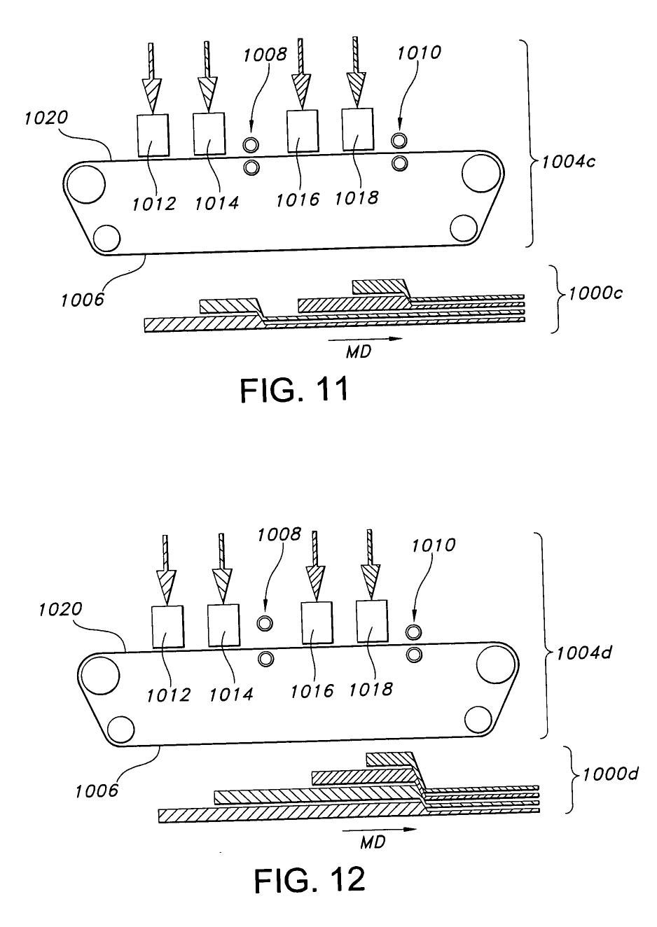

Referring next to FIG. 11, the illustrated system includes a machine 1004c used to form a unitized airlaid 1000c. In this system, both the upstream rolls 1008 and downstream rolls 1010 are utilized as compression rolls, thereby yielding a thinned web of fabric having a substantially constant density.

Referring now to FIG. 12, which illustrates a machine 1004d used to form a web 1000d, only the downstream rolls 1010 are utilized as compression rolls (upstream rolls 1008 are not so utilized). Accordingly, machine 1004d provides for an overall compression of the web, thereby yielding a thinned fabric of substantially constant density, similar in respects to the web 1000c formed according to the system illustrated in FIG. 11.

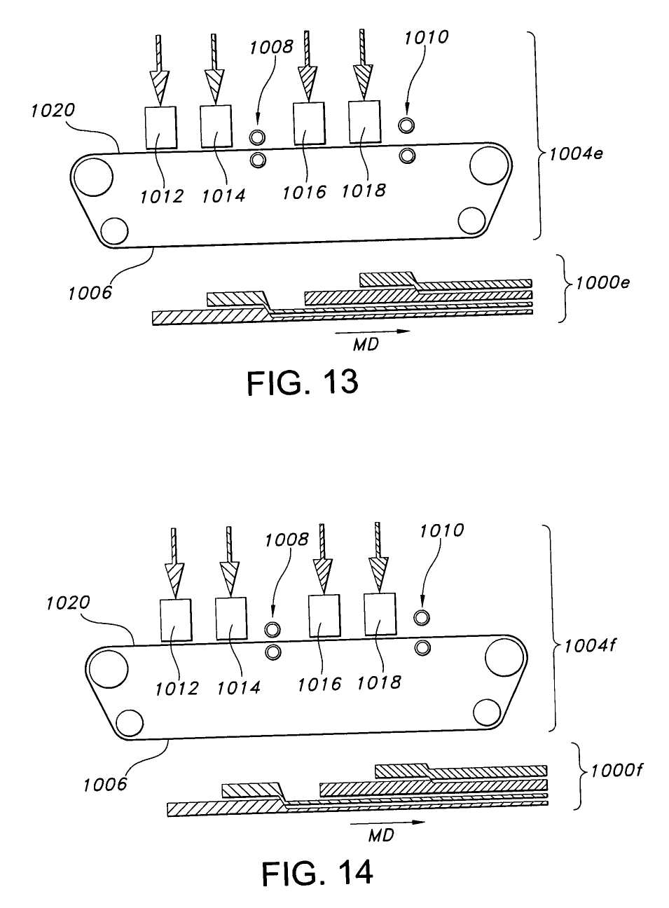

Referring now to FIG. 13, a machine 1004e is used to form a web 1000e. Machine 1004e utilizes both the upstream rolls 1008 and the downstream rolls 1010 as compression rolls but with varying degrees of compression. More specifically, upstream rolls 1008 are utilized as compression rolls while downstream rolls 1010 are provided for partial compression. Accordingly, machine 1004e yields a gradient density web (as illustrated schematically by the relative thicknesses of the zones of the web 1000e), but the web 1000e differs from the web 1000b shown in FIG. 10 and the web 1000c shown in FIG. 11 with respect to the thickness and densities of zones in the web 1000e (e.g., the top two zones of the respective webs).

Referring to FIG. 14, a machine 1004f forms a web 1000f that is similar to the web 1000e illustrated in FIG. 13. Web 1000f differs from web 1000e in the degree of compression provided by downstream rolls 1010, thereby yielding thicker zones of material deposited via the third and fourth heads 1016 and 1018.

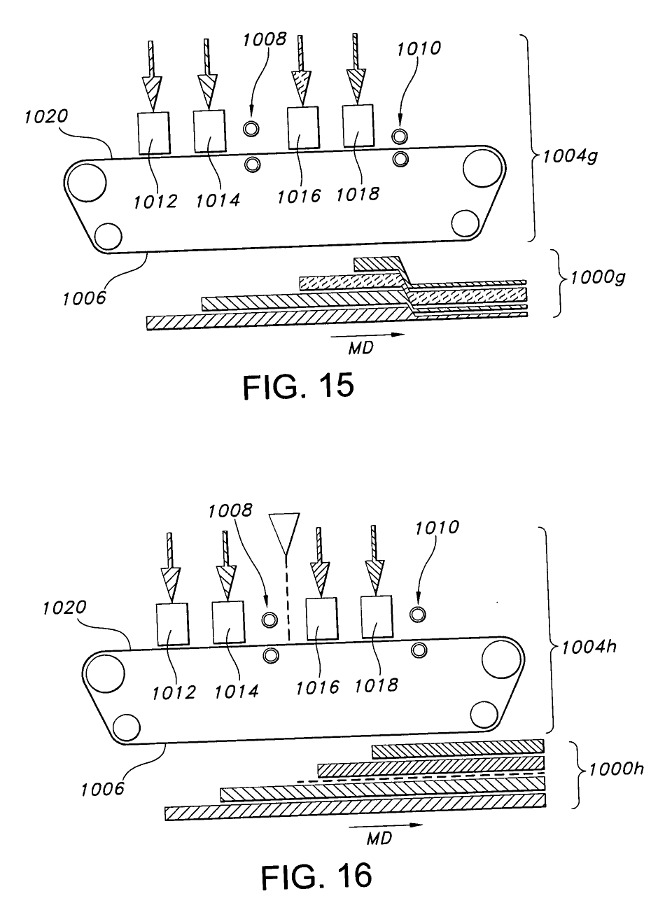

Referring now to FIG. 15, a machine 1004g yields a web 1000g. The system illustrated in FIG. 15 is similar to that illustrated in FIG. 12 except that a resilient fiber is introduced through one of the heads. Specifically, a resilient fiber (e.g., a polyester fiber) is introduced to the web via the third head 1016, wherein the fiber introduced via head 1016 differs from that introduced via heads 1012, 1014, and 1018 at least in terms of its resiliency. Because of the resiliency of the fiber introduced through the third head 1016, the zone thus produced tends to “bounce back” to or toward its original shape after passing through downstream rolls 1010, thereby yielding a more bulky and lower density central zone surrounded by substantially thinner zones. Such a zone is optionally provided at any location across the thickness of the web, including top and bottom zones of the web.

FIGS. 16 through 19 illustrate systems that differ from those illustrated in FIGS. 9 through 15 in that one or more separate raw material components are introduced into the web by the machine. The separate component is optionally a pre-formed web of material such as a meltblown or spunbonded web. Preferably, the separate component is formed in situ to reduce manufacturing costs. A wide variety of other materials are contemplated as well.

Referring to FIG. 16, a machine 1004h is used to form a web 1000h that includes a web of material between adjacent zones of the web 1000h formed through the second and third heads 1014 and 1016. More specifically, a mechanism is provided in machine 1004h to introduce a web at a location between the second head 1014 and third head 1016, thereby interposing the web material between the zones of the web 1000h formed by the second head 1014 and third head 1016. Accordingly, the resulting web 1000h is similar to the web 1000a formed by the machine 1004a (FIG. 9), except that an additional web material has been introduced into the web 1000h between zones of the web 1000h.

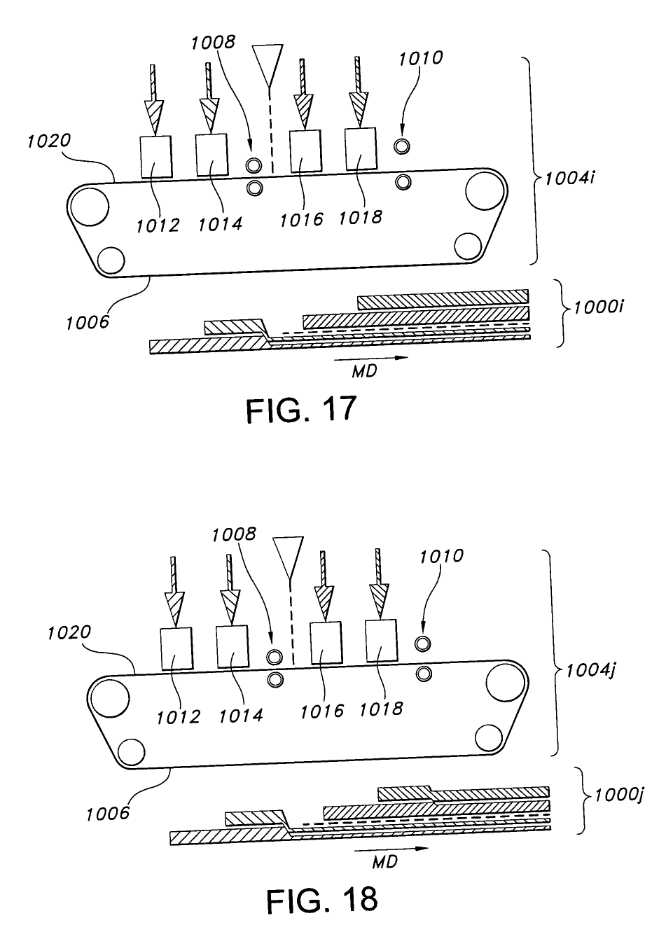

Referring to FIG. 17, a machine 1004i produces a web 1000i. Web 1000i is similar to web 1000b (FIG. 10) in that the upstream rolls 1008 are utilized as compression rolls to compress the first two zones deposited by means of first head 1012 and second head 1014. Web 1000i is also similar to web 1000h (FIG. 16) in that separate web material is introduced between the zones deposited by the second and third heads 1014 and 1016.

Referring to FIG. 18, a machine 1004j is used to form a web 1000j. Web 1000j is similar to web 1000f (FIG. 14) in terms of compression ratios and similar to web 1000h (FIG. 16) in terms of the introduction of a separate web composite.

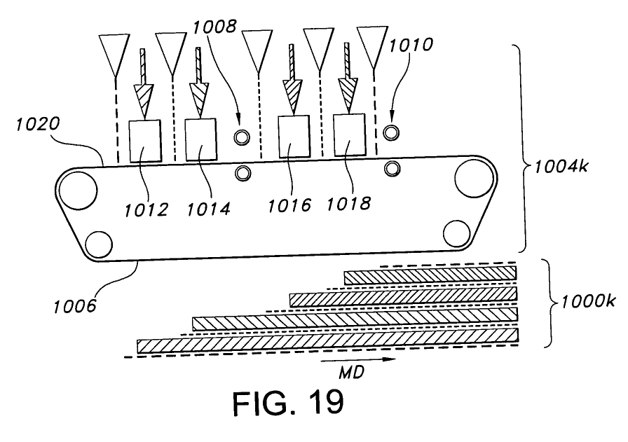

Referring now to FIG. 19, a machine 1004k is used to form a web 1000k. The schematic illustration provided in FIG. 19 demonstrates that multiple components (the same or different components) can be provided via heads positioned between the airlaid forming heads. For example, heads can be provided for the introduction of web materials (e.g., spunbonded or meltblown materials or films) at one or any combination of locations upstream and downstream of the heads 1012, 1014, 1016 and 1018. In machine 1004k, such supplemental heads are provided upstream of first head 1012, between first head 1012 and second head 1014, between second head 1014 and third head 1016, between third head 1016 and fourth head 1018, and downstream from fourth head 1018 and upstream of downstream rolls 1010. Any combination of such supplemental heads can be utilized, and such heads can be used to introduce the same or different components in any combination. Also, although not shown in FIG. 19, the upstream rolls 1008 and downstream rolls 1010 can be utilized in any combination as compression rolls in order to compress selected zones of the resulting web 1000k.

It is also contemplated that an article is optionally produced by forming a unitized airlaid composite directly onto a substrate. For example, an article such as a cleaning pad is optionally produced by forming a unitized airlaid composite directly onto a porous substrate such as a light weight spunbond or other suitable substrate.

Although examples of unitized airlaid composite forming systems are illustrated in the figures, together with descriptions of possible modifications or variations of the illustrated systems, this invention is not limited to the particular airlaid composite forming systems selected for illustration in the figures, and this invention is not limited to an absorbent pad having a unitized airlaid structure. Other airlaid forming systems and other pad-producing processes are contemplated as well.

For example, an exemplary airlaid machine is available for use at Marketing Technology Service, Inc. of Kalamazoo, Michigan Additionally, airlaid systems are available through MJ Fibretech of Hörstens, Denmark and Dan-Web of Aarhus, Denmark. Further, an exemplary airlaid process is disclosed in PCT International Publication No. WO 2004/097097 of Dan-Web Holding A/S, which is incorporated herein by reference.

Independent of the particulars of the system used to form an airlaid structure, unitized airlaid structures according to aspects of this invention exhibit performance characteristics comparable to, or exceeding, those of products made by other processes such as those used for laminating multiple fabrics. Additionally, benefits are achieved by utilizing a unitized airlaid structure because it reduces costs associated with lamination, including costs from converting waste and lost manufacturing efficiency from down time caused by the complexity of the lamination process. It is believed that converting losses of about 5% or more, and perhaps as much as 15% or more, are associated with lamination processes. Also, lamination speeds may be limited by different stretch, neck-in and tensile strengths of the fabrics to be combined. And there are also costs associated with the lamination adhesive setup and cleanup. In addition, there may be a reduction in overall loft of the fabric (higher density) in a laminated structure, which may be undesirable.

Lamination processes may require storage of various, different roll goods and associated quality control, multiple roll good vendors, and the cost of shipping, delivering, testing and certifying the roll goods. Also, each fabric incorporates its own material waste problems as a result of its own manufacturing process.

With an airlaid process according to aspects of this invention, a variety of strength and surface textures can be achieved based on selection of fibers, forming wires, resins and compression strategies. By employing plural forming heads and separate fiber feeds, for example, maximum flexibility is provided in the product design. For example, functional surfaces can be provided with unique characteristics as compared to internal regions of the airlaid composite. In exemplary embodiments, more expensive fiber zones can be positioned adjacent cheaper inner ingredients.

Additionally, airlaid fibers are optionally deposited on top of pre-existing fabrics, e.g. a spunbond or hydroentangled web. With such constructions, the stability of the web being formed should be monitored, including such properties as stretch, shrinkage and its ability to be bonded at the preferred temperatures. Additional functionality is optionally added to the unitized airlaid structure by using spray emulsion polymer adhesive techniques to add such things as color, odor reduction, and scrubby surfaces, for example.

Another advantage of unitized airlaid webs is the substantially non-directional nature of the webs produced, where tensile strength in the machine direction MD and cross direction CD is approximately the same. This is not the case, for example, with carding or spunbonding, which tend to show substantial directionality. Accordingly, such directional alternatives would require higher amounts of material to provide adequate strength. Although a unitized airlaid system exhibits advantages as compared to such other forming systems and structures, such other systems (including lamination) are within the scope of this invention especially when used in conjunction with airlaid systems. It is recognized that some materials (e.g., spunbond webs) are ubiquitous and inexpensive, and therefore such materials may be beneficially used, preferably in conjunction with airlaid unitized structures.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention. Also, the embodiments selected for illustration in the figures are not shown to scale and are not limited to the proportions shown. Finally, though the foregoing description relates primarily to the field of disposable floor mops for purposes of illustration, the benefits conferred by this invention are also applicable in other fields including, for example, two-sided wipes, unitized filtration media, automotive applications (e.g., filters and fabrics for noise reduction), insulation (e.g., sound and thermal insulation), aerospace composites, and specialty packaging (e.g., for cushioning or absorbent properties). Other applications are contemplated as well.

What is claimed:

1. A surface cleaning pad comprising a pad body having a matrix web formed from binder fibers and at least one cleaning surface configured for contact with a surface to be cleaned, wherein a density of said matrix web at the cleaning surface is greater than a density of said matrix web at a location spaced from the cleaning surface.

2. The surface cleaning pad of claim 1, wherein said pad body is formed from a unitized airlaid composite.

3. The surface cleaning pad of claim 2 further comprising cellulosic fibers disbursed throughout said pad body.

4. The surface cleaning pad of claim 2 further comprising superabsorbent polymer particles disbursed throughout said pad body.

5. The surface cleaning pad of claim 1, said pad body defining a plurality of cleaning surfaces.

6. The surface cleaning pad of claim 1, wherein the density of said matrix web at said cleaning surface is at least about 50 percent greater than the density of said matrix web at a location spaced from said cleaning surface.

7. The surface cleaning pad of claim 1, wherein the density of said matrix web at said cleaning surface is at least about 100 percent greater than the density of said matrix web at a location spaced from said cleaning surface.

8. In a cleaning pad comprising a matrix web formed from binder fibers and a cleaning surface, a method of forming the cleaning pad comprising the steps of:
depositing a first concentration by weight of binder fibers so as to at least partially define the cleaning surface;
depositing a second concentration by weight of binder fibers, wherein the second concentration by weight of binder fibers is less than the first concentration by weight of binder fibers; and
bonding the binder fibers to form the matrix web.

9. The method of claim 8, wherein said second depositing step further comprises depositing cellulosic fibers.

10. The method of claim 8, wherein said second depositing step further comprises depositing superabsorbent polymer particles.

11. The method of claim 8, wherein said first concentration by weight of binder fibers is at least about 50 percent greater than said second concentration by weight of binder fibers.

12. The method of claim 8, wherein said first concentration by weight of binder fibers is at least about 100 percent greater than said second concentration by weight of binder fibers.

13. The method of claim 8, further comprising the step of depositing a third concentration by weight of binder fibers so as to define a second cleaning surface, wherein the third concentration by weight of binder fibers is greater than the second concentration by weight of binder fibers.

14. In a cleaning pad comprising a matrix web formed from binder fibers and a cleaning surface, a method of forming the cleaning pad comprising the steps of:
depositing a first portion of substrate comprising binder fibers so as to define the cleaning surface;
densifying the first portion of substrate;
depositing a second portion of substrate comprising binder fibers onto the first portion of substrate; and
bonding the first and second portions of substrate to form the matrix web.

15. The method of claim 14, wherein said second depositing step further comprises depositing superabsorbent polymer particles onto the first portion of substrate.

16. The method of claim 14, wherein a concentration by weight of binder fibers in the first portion of substrate is greater than a concentration by weight of binder fibers in the second portion of substrate.

17. The method of claim 14, wherein a concentration by weight of binder fibers in the first portion of substrate is substantially the same as a concentration by weight of binder fibers in the second portion of substrate.

18. In a cleaning pad comprising a matrix web formed from binder fibers and a cleaning surface, a method of forming the cleaning pad comprising the steps of:
depositing a first portion of substrate comprising binder fibers so as to define the cleaning surface;
depositing a second portion of substrate comprising binder fibers and non-binder fibers onto the first portion of substrate, wherein the second portion of substrate comprises a concentration by weight of non-binder fibers greater than a concentration of any non-binder fibers in the first portion of substrate; and
bonding the first and second portions of substrate to form the matrix web.

19. The method of claim 18, wherein said first depositing step comprises depositing a mixture of non-binder fibers and binder fibers.

20. The method of claim 19, wherein said first depositing step comprises depositing a mixture of cellulosic fibers and binder fibers.

21. The method of claim 18, wherein said second depositing step comprises depositing binder fibers and cellulosic fibers.

22. The method of claim 18, further comprising the step of depositing superabsorbent polymer particles.

23. The method of claim 18, further comprising the step of densifying the matrix web.

24. A surface cleaning pad comprising a pad body including binder fiber material and at least one cleaning surface configured for contact with a surface to be cleaned, wherein a concentration by weight of said binder fiber material at the cleaning surface is greater than a concentration by weight of said binder fiber material at a location spaced from the cleaning surface.

25. The surface cleaning pad of claim 24, wherein said pad body is formed from a unitized airlaid composite.

26. The surface cleaning pad of claim 24 further comprising cellulosic fibers disbursed throughout said pad body.

27. The surface cleaning pad of claim 24 further comprising superabsorbent polymer particles disbursed throughout said pad body.

28. A surface cleaning pad comprising a pad body including non-bonding fibrous material and bonding fibrous material and having at least one cleaning surface configured for contact with a surface to be cleaned, wherein a concentration by weight of said non-bonding fibrous material at the cleaning surface is less than a concentration by weight of said non-bonding fibrous material at a location spaced from the cleaning surface.

29. The surface cleaning pad of claim 28, wherein said pad body is formed from a unitized airlaid composite.

30. The surface cleaning pad of claim 29, said non-bonding fibrous material comprising cellulosic fibers.

31. The surface cleaning pad of claim 30 wherein an absorbent capacity of said airlaid composite is at least approximately 25 grams/gram.

32. The surface cleaning pad of claim 30 wherein an absorbent capacity of said airlaid composite is at least approximately 28 grams/gram.

33. The surface cleaning pad of claim 29 wherein a tensile strength of said airlaid composite is at least approximately 2000 gf.

34. The surface cleaning pad of claim 29 wherein a tensile strength of said airlaid composite is at least approximately 5000 gf.

35. The surface cleaning pad of claim 29 wherein a tensile strength of said airlaid composite is at least approximately 6500 gf.

36. The surface cleaning pad of claim 29 wherein a tear strength of said airlaid composite is at least approximately 300 gf.

37. The surface cleaning pad of claim 29 wherein a tear strength of said airlaid composite is at least approximately 800 gf.

38. The surface cleaning pad of claim 29 wherein a tear strength of said airlaid composite is at least approximately 1000 gf.

39. The surface cleaning pad of claim 29 wherein a coefficient of friction between said cleaning surface of said airlaid composite and the surface to be cleaned is less than approximately 2.5 when said airlaid composite is dry or less than approximately 2.0 when said airlaid composite is wet.

40. The surface cleaning pad of claim 39 wherein the coefficient of friction is less than approximately 2.0 when said airlaid composite is dry.

41. The surface cleaning pad of claim 39 wherein the coefficient of friction is about 1.5 or less when said airlaid composite is dry.

42. The surface cleaning pad of claim 39 wherein the coefficient of friction is less than approximately 1.5 when said airlaid composite is wet.

43. The surface cleaning pad of claim 39 wherein the coefficient of friction is about 1.2 or less when said airlaid composite is wet.

44. A surface cleaning pad configured for contact with a surface to be cleaned, said surface cleaning pad comprising:
a unitized airlaid composite body having:
a proximal zone defining a cleaning surface configured for contact with the surface to be cleaned, said proximal zone occupying a portion of said unitized airlaid composite body and said proximal zone comprising bonding fiber material,
a distal zone adjacent said proximal zone on a side opposite said cleaning surface, said distal zone occupying another portion of the thickness of said unitized airlaid composite body, and said distal zone comprising bonding fiber material,
wherein a concentration by weight of said bonding fiber material in said proximal zone is greater than a concentration by weight of said bonding fiber material in said distal zone; and
means for attaching said unitized airlaid composite body to a cleaning implement.
